(19) United States
(12) Patent Application Publication
(10) Pub. No.: US 2021/0360995 A1
(43) Pub. Date: Nov. 25, 2021

(54) Aerosol Reduction Mask

(71) Applicant: Tom Lough, Round Rock, TX (US)

(72) Inventor: Tom Lough, Round Rock, TX (US)

(21) Appl. No.: 17/151,091

(22) Filed: Jan. 15, 2021

Related U.S. Application Data
(60) Provisional application No. 63/029,673, filed on May 25, 2020.

(51) Int. Cl. A41D 13/11

(52) U.S. Cl. CPC A41D 13/1107

(57) ABSTRACT

A device and method for manufacturing a specially designed face mask that allows the free and vigorous inhalation of air for singing and speaking is disclosed. A minimalization of the broadcast of aerosolization particles as exhaled air is directed downward toward a variety of filter materials. The mask has at least one layer of material and at least one method of holding the mask in place in front of the nose and mouth of the wearer. The mask is designed to function such that the material is suspended away from the openings of the mouth and nose, including being held in place in front of the nose and mouth openings by one of any number of methods, such as elastic straps around the head, elastic loops around the ears, or other means.

### BACKGROUND

Infectious particles in the form of aerosol particulates released through the nose and mouth during speaking, singing, and general exhaling can contaminate the air that others breathe and the articles/surfaces that others touch. Non-infected individuals who breathe these infectious particles or who touch infected surfaces and then touch their own body openings can become infected themselves. FIG. 14 (Prior Art) shows an example of this. One method to prevent the spread of these infectious aerosol particulates is to cover the nose and mouth with a full-face medical mask connected to its own air supply. Unfortunately, this is not practical for day-to-day living.

Other measures, such as homemade cloth face masks, have uncertain effectiveness but have achieved a high level of acceptance and use. These face masks generally consist of one or more layers of material that fit tightly across the mouth and nose area. When a person wearing such a mask inhales sharply, as is the case for a singer preparing to sound a note, the material of the mask is pulled into the mouth area, greatly restricting the quantity of air supplied to the lungs. Thus, there is a significant and unmet need for a system or device that can minimize the broadcast of aerosol particulates into the environment while providing for a free supply of inhaled air to a person who is participating in singing, speaking, or other activities.

### SUMMARY

The embodiments herein comprise a mask, system, and method to minimize direct broadcast of aerosolized particles produced during speaking, singing, or other similar activity and expelled through the mouth or nose. More specifically, the present invention relates to a device and method comprising the use of a specially designed face mask that allows the free and vigorous inhalation of air for singing, speaking, etc., and the minimalization of the broadcast of aerosolization particles as exhaled air is directed downward toward a variety of filter materials. An example embodiment is directed to a device comprising a face mask with at least one layer of material and at least one method of holding the mask in place in front of the nose and mouth openings.

In an embodiment, the mask is designed to function such that the material is suspended away from the openings of the mouth and nose. In an embodiment, the mask is designed to be held in place in front of the nose and mouth openings by one of any number of methods, such as elastic straps around the head, elastic loops around the ears, or other means. In an embodiment, the material of the mask extends downward to a point of contact or near contact with the body of the individual.

One goal of the mask is to restore choral singing to the world by developing a safe and practical singing mask for church choirs, glee clubs, community choruses, and other singing groups. The various embodiments of the mask achieve this by (a) eliminating or significantly reducing any frontal aerosol plume generated by a singer (as shown in FIG. 14 Prior Art), and (b) providing an unobstructed pathway to support the vigorous inhalation and exhalation of a singer. In addition, the mask is comfortable, adjustable, easily identifiable, easily sanitized, affordable, and supported by credible research as being safe to use.

### BRIEF DESCRIPTION OF DRAWINGS

FIG. 1 illustrates various embodiments of a mask system;

FIG. 2 shows the right side panel;

FIG. 3 shows the middle panel;

FIG. 4 shows the left side panel;

FIG. 5A, FIG. 5B, FIG. 5C, and FIG. 5D illustrate how the mask is worn;

FIG. 6 shows layers of the right side panel;

FIG. 7 shows layers of the middle panel;

FIG. 8 shows layers of the left side panel;

FIG. 9A shows alignment of panels for joining to form a layer;

FIG. 9B shows an example layer of joined panels;

FIG. 10 shows how layers are joined together;

FIG. 11 shows an example finished mask with nose strip and supplemental stitching;

FIG. 12 shows filtering mechanism;

FIG. 13A and FIG. 13B show elements of a tangential capture mechanism;

FIG. 14 shows a Prior Art arrangement of an aerosol plume;

FIG. 15 shows flat metal center nose reinforcing strips; and

FIG. 16A and FIG. 16B show example testing environments.

### DETAILED DESCRIPTION OF PREFERRED EMBODIMENTS

Various embodiments of a mask 100 are shown and described herein. Specifically, the mask 100 is worn by an individual to minimize the direct broadcast of aerosolized particulate matter emanating from the nose and mouth as a result of the act of singing, speaking, etc. Moreover, the mask 100 provides a clear pathway for air to travel into and out of the nose and mouth, so that a person engaging in singing, speaking, other movements associated with a choir e.g. swaying, will be able to inhale vigorously without the material of the face mask obstructing the intake of breath.

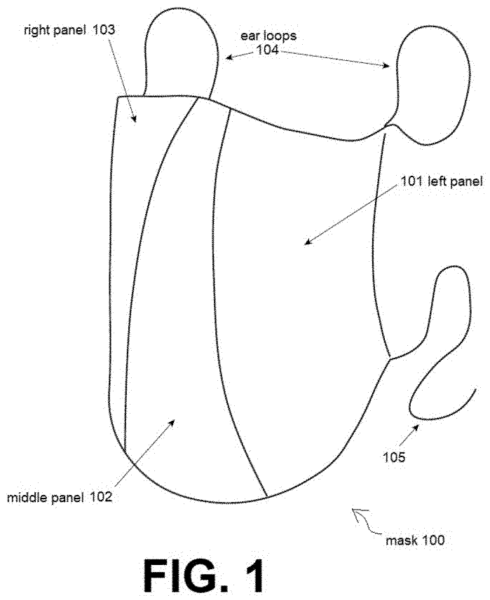

FIG. 1 shows the mask system 100 comprising side panels 101 and 103, a middle panel 102, and elastic ear loops 104 and elastic ties 105. However, the embodiments herein should not be considered as limited exclusively thereto, but instead merely one of many possibilities.

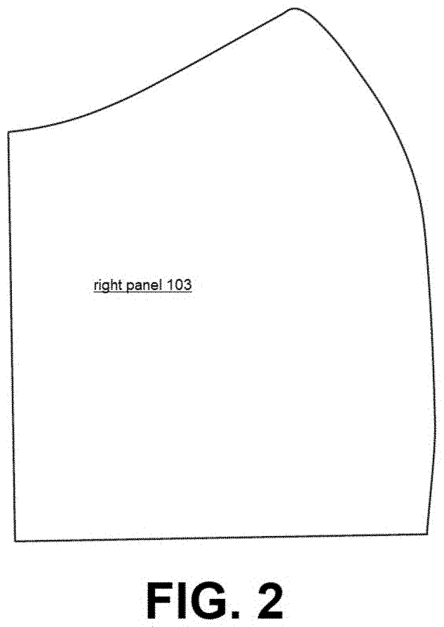

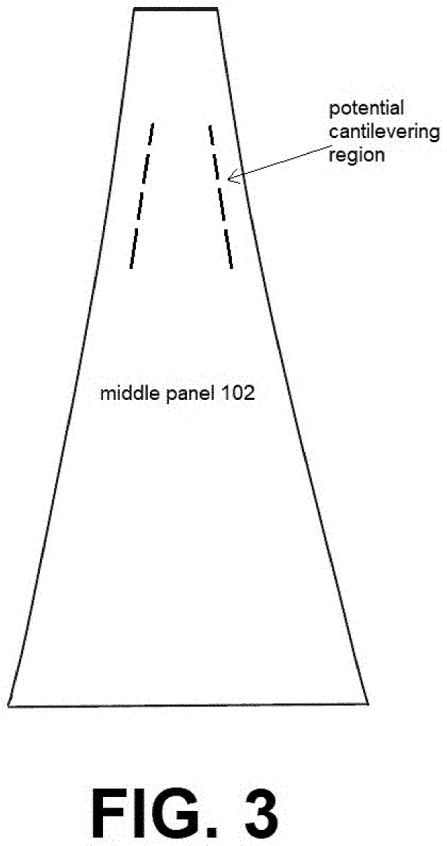

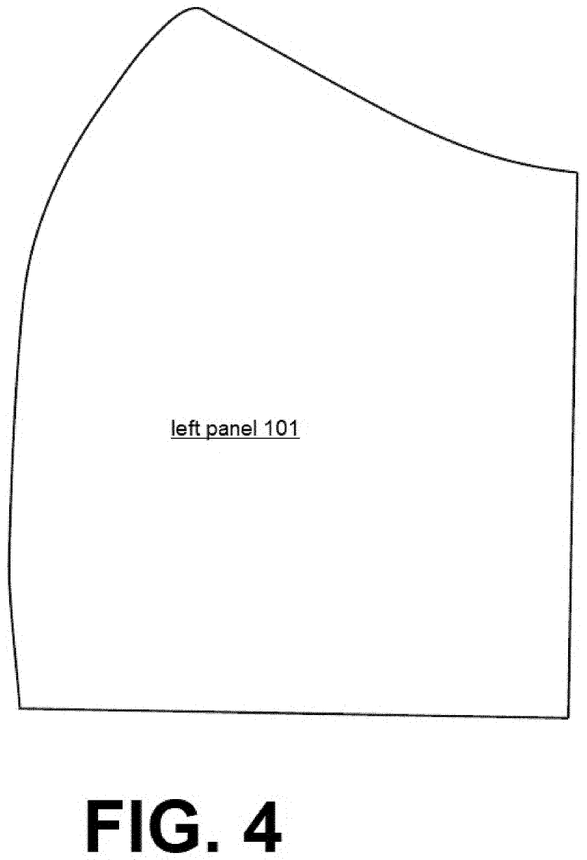

The system 100 comprises multiple components. When the two side panels 101 and 103 are sewn or otherwise joined together at the middle panel 102 as shown in FIG. 1, their mutual curvatures create a system of two arches which serve to support and cantilever (verb) the material of the mask down and out from the tip of the nose of the wearer. FIG. 2 shows the right side panel 103. FIG. 3 shows the middle panel 102. FIG. 4 shows the left side panel 101.

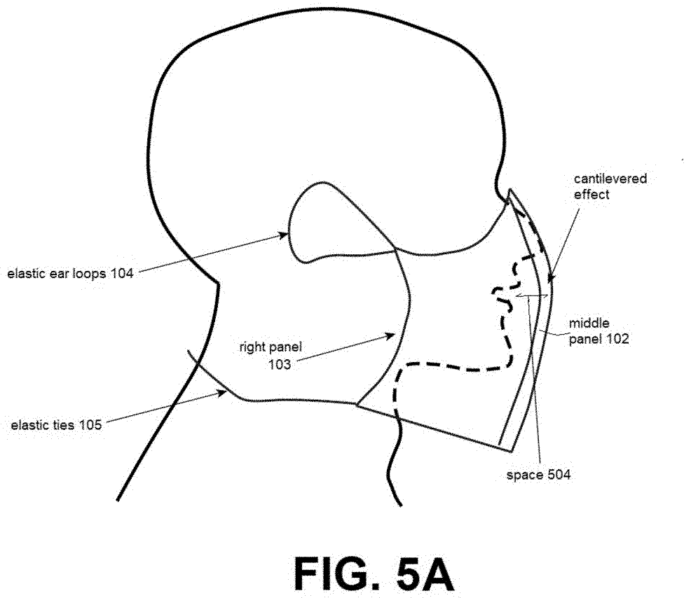

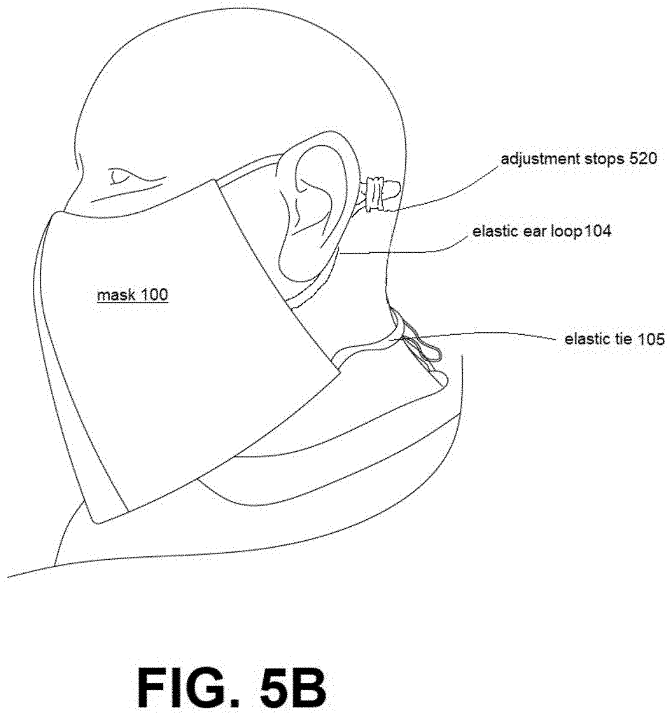

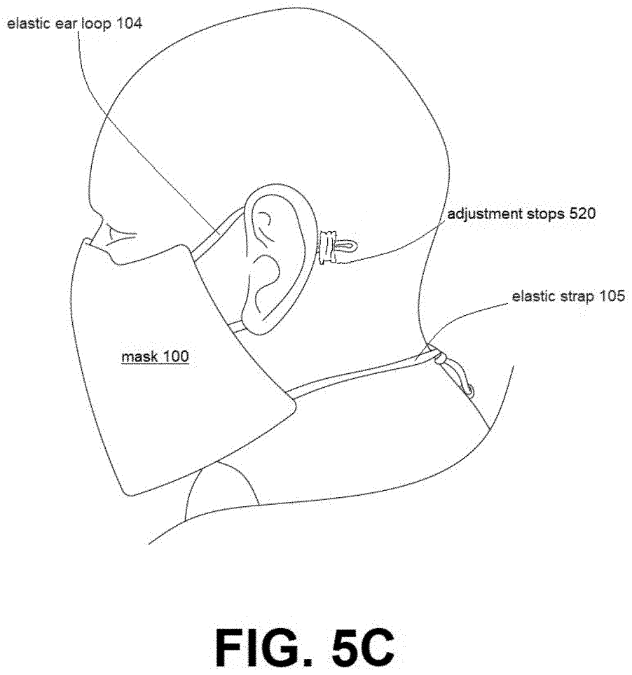

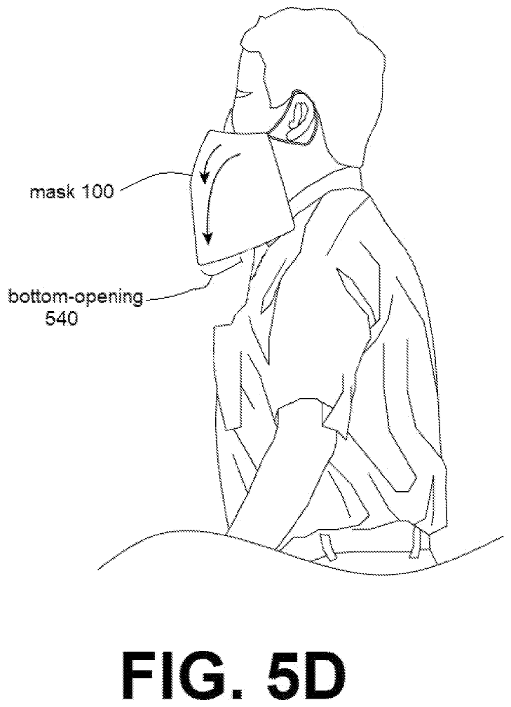

FIGS. 5A-5D illustrate how the mask 100 is worn on the face of the individual. To assist in the cantilevering, the middle panel 102 can be made of a stiffer less bendable material than the panels 101/103. Alternative, the middle panel 102 can be sprayed or treated with a material that aids in stiffening, or a material that reacts with a higher-rigidity composition. As shown in FIG. 5A, this cantilevering creates a space 504 between the nose and mouth and the panels 103/102 (panel 101 also, but panel 101 is not visible in FIG. 5A) so that the panels 101/102/103 are not pulled into the mouth or nose upon vigorous inhalation. Likewise, as shown at least within FIG. 5D, upon exhalation, the air is directed outward and then downward (note the arrows in FIG. 5D) toward the panels 101/102/103, which in an embodiment may include additional layers of filter material to further inhibit the aerosolized particulate matter.

Nonetheless, even without documentation and measurement, the embodiments of the mask system 100 provide a way to control such releases and reduce the risk for human exposure. Further, a customized and proprietary test environment and methodology is described below.

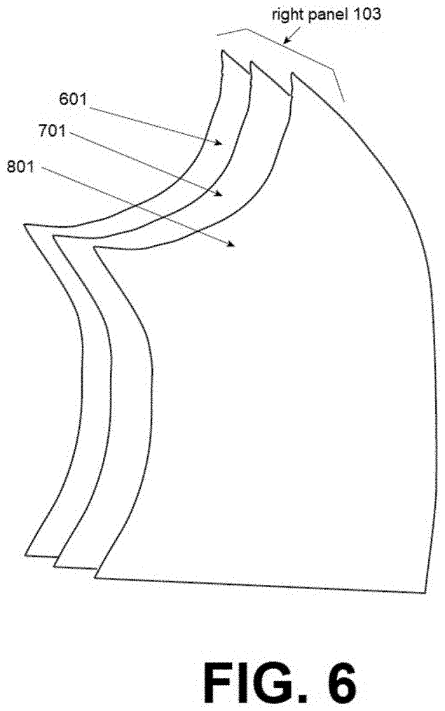

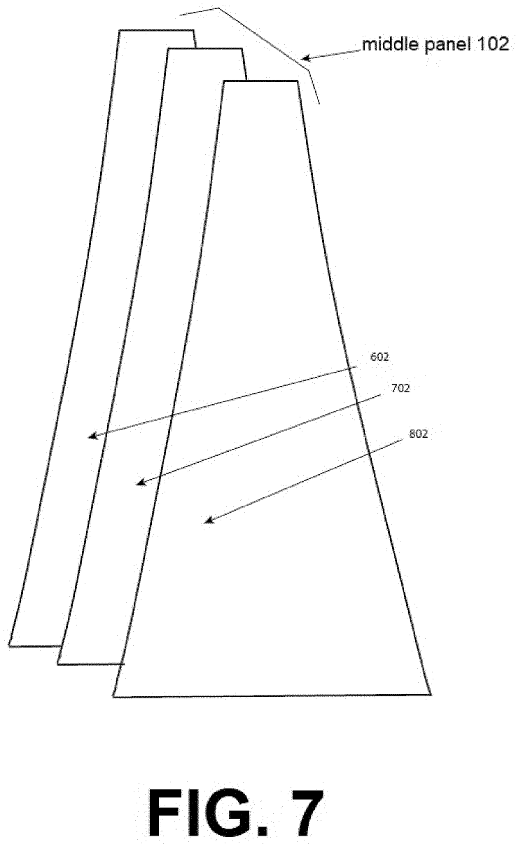

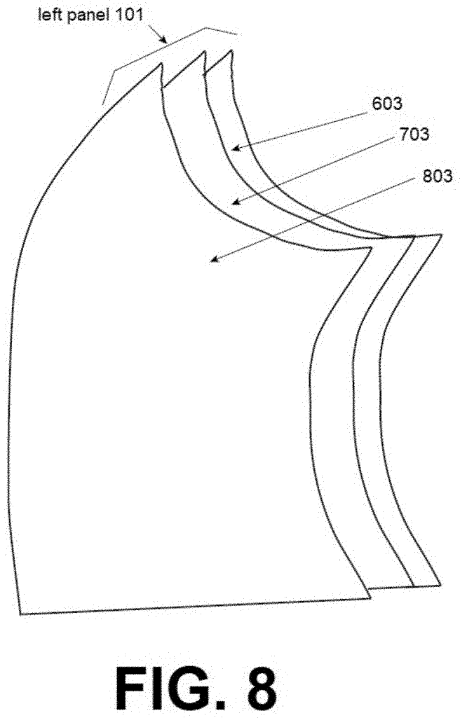

As shown in FIGS. 6-8, in an embodiment, each of the panels 101, 102, and 103 comprise an external layer 801/802/803 of woven cotton material, an intermediate layer 701/702/703 of nonwoven interfacing material, and an interior skin-facing layer 601/602/603 of woven cotton material. In an embodiment, the elastic ties 105 are adjustable and thus allow a wearer to adjust the mask for a comfortable individual fit.

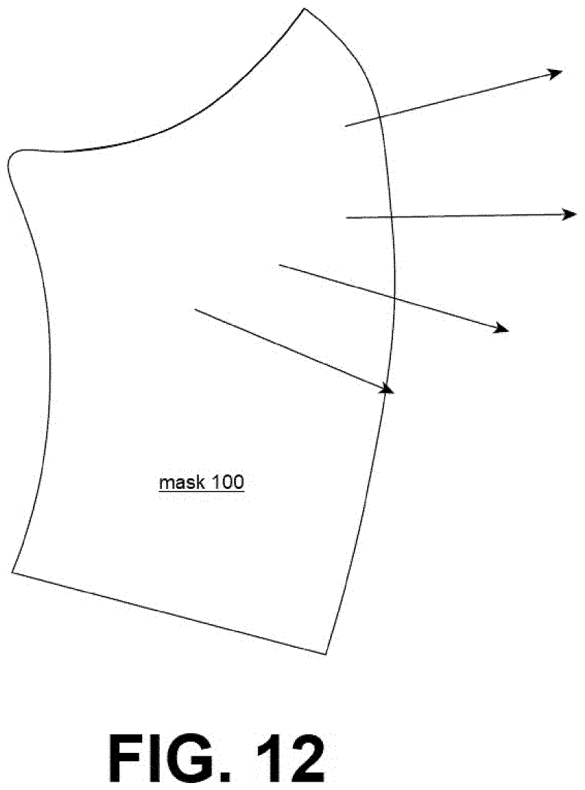

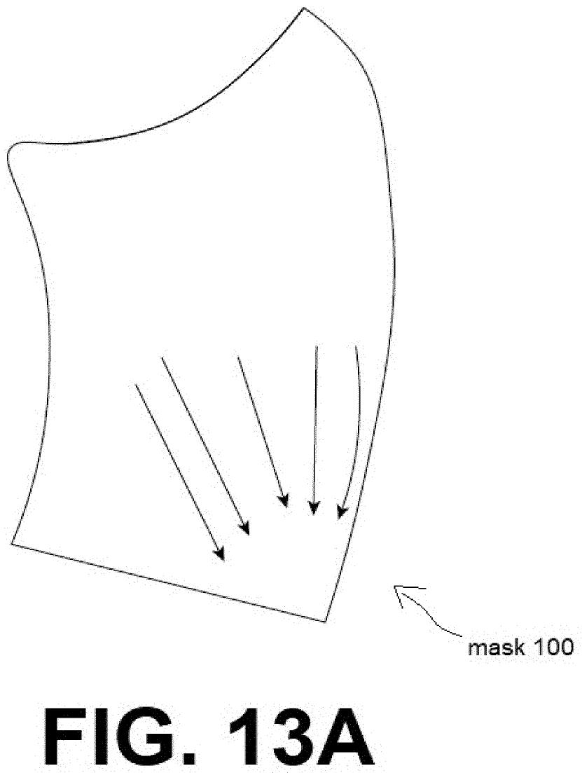

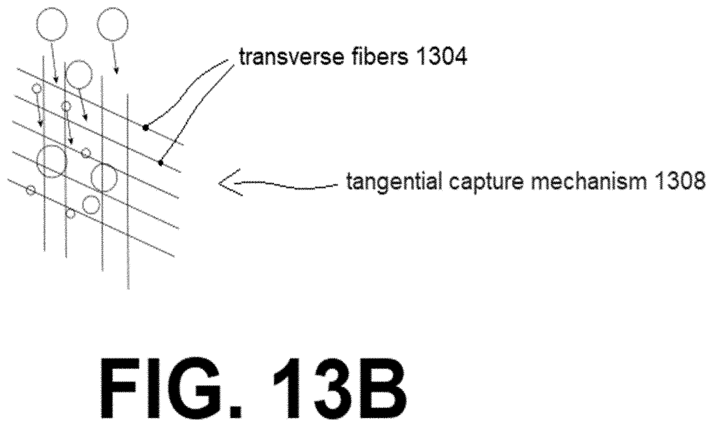

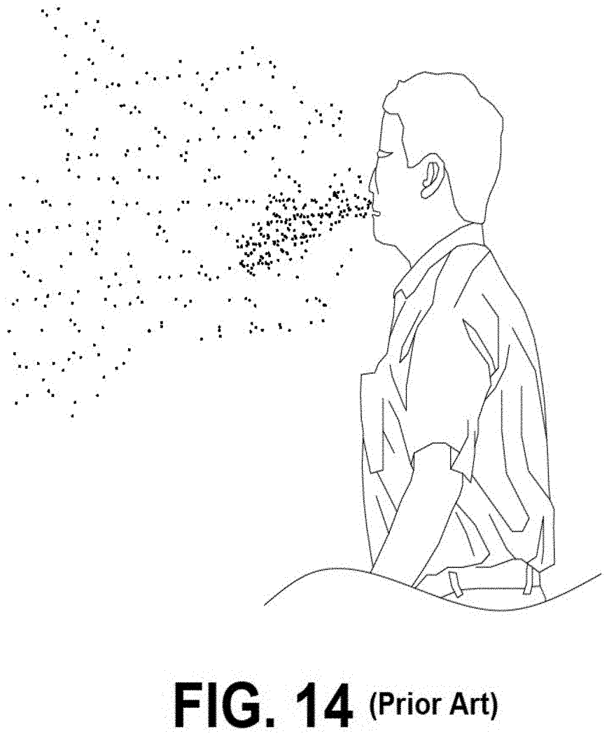

The embodiments here also incorporate an aerosol theory with a combination of mechanisms to describe the mask effectiveness and its ability to mitigate risk and filter panicles from aerosol transmission. Specifically, filtering is shown in FIG. 12, tangential capture by, interception is shown in FIGS. 13A-13B.

This arrangement permits the mask 100 to make its claims of safety, because the aerosol particles that are moving downward toward the small opening are captured by interception within the fabric the aerosol particles are passing over. This is counterintuitive, because the conventional wisdom is that the most effective masks are tightly sealed all around. This is true for N-95 products which capture a high % of aerosol particles. But, unfortunately, the N-95 masks make it harder to breathe.

In contrast, the mask 100 implements an aerosol capture mechanism to contain aerosol particles within the mask. Only natural air e.g. oxygen, carbon dioxide, nitrogen is exiting the opening 540 at a bottom side of the mask 100. The aerosol particles, e.g. those particles larger than natural air, do not exit the opening 540 in any measurable quantities.

Specifically, the expelled air moves down toward and through the opening 540 at the base of the mask 100. Along the way, that air is forced to move in a direction tangential to the fabric of the lower half of the mask 100, as shown in FIG. 13A. Because of the expanded space through which the expelled air travels, its speed is reduced as well. The “stickiness” of the aerosol particles traveling along or near the surface of the mask increases because the speed of the particles is reduced. This in turn promotes capture by the interior layer of material forming the mask. This tangential capture mechanism takes place mainly in the lower half of the mask 100, as shown in FIG. 13A.

Because the aerosol particles are traveling along an interior surface of the lower part of the mask 100, or are traveling toward that material at a shallow angle of attack, the size of the mesh does not come into play. The transverse mesh fibers 1304 shown in FIG. 13B achieve a near-solid surface to the aerosol particles, thus capturing particles of all sizes thereby foraging a tangential capture mechanism 1308. That is, the tangential capture mechanism 1308 shown in FIG. 13B is size-independent.

### Testing and Test Environment

A simulation and testing facility for studying human aerosol emissions and exposures is also disclosed. This testing facility comprises a temperature- and humidity-controlled chamber and operates under a computer-controlled, HEPA-filtered air delivery system. The facility can be sterilized, purged with clean air in a matter of minutes, and is operated with sophisticated equipment to monitor aerosol size and concentration, human respiration and activity rate, and environmental variables e.g. temperature, pressure, relative humidity.

In arriving at and testing the mask 100, a rate (and size) of bioaerosol emitted by performers of varying age and gender when engaging in music and voice was considered. In this testing, it was found advantageous to establish the magnitude and variability of aerosol release rates, as a function of particle size, during vocalizing across a range of volume and pitch during singing and speaking. This in turn obtained a scientifically rigorous dataset on endogenous particle release rates (e.g. stratified by gender, age, and activity type).

This testing shows that the mask system 100 can contain 90% or more of aerosol particles 4 micrometers in diameter or larger.

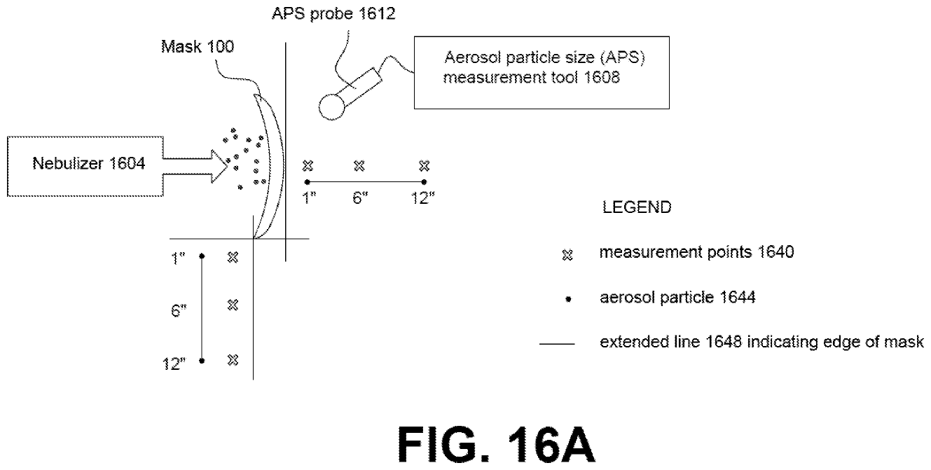

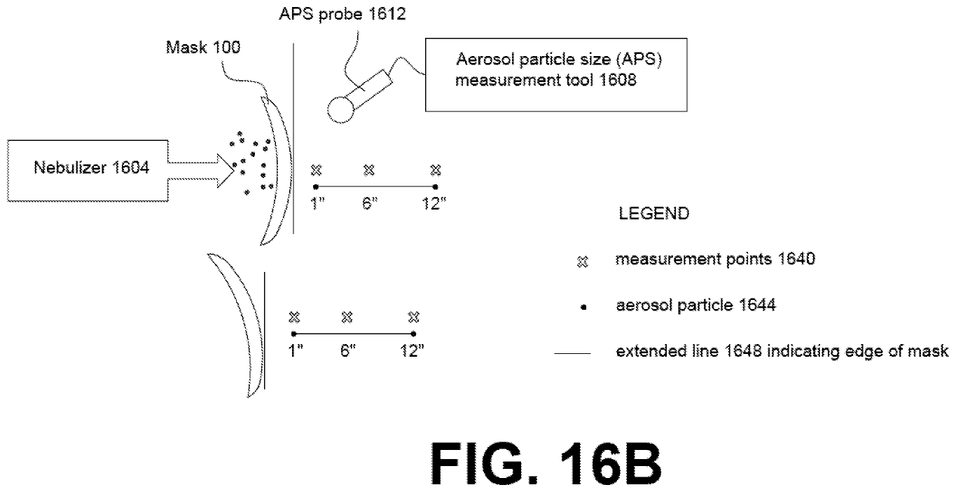

The effectiveness of the tangential capture (filtration) mechanism 1308 was determined by the results of a collection efficiency assessment. The effectiveness of the tangential capture mechanism was determined by a customized experiment with a nebulizer and a detector at an aerosol engineering laboratory. Specifically, FIG. 16A shows a test environment 1600_{M} (Mask-only) with the mask 100 by itself. Meanwhile, FIG. 1.6B shows a test environment 1600_{MR} (Mask-Robe) having a mask 100 and a choir robe positioned underneath.

In both FIGS. 16A-16B, it is apparent that no aerosol particles larger than 3 micrometers were detected in front of the mask 100, beneath the mask 100, or in front of the choir robe.

### Method of Manufacture

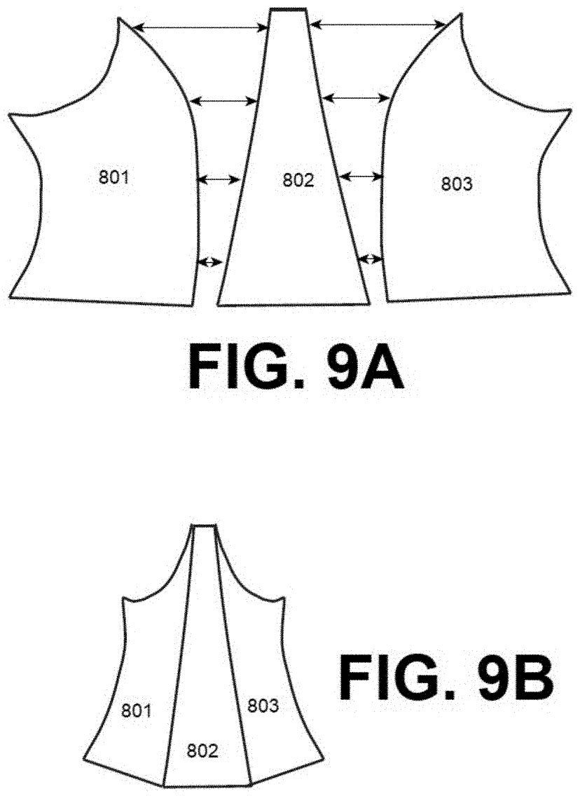

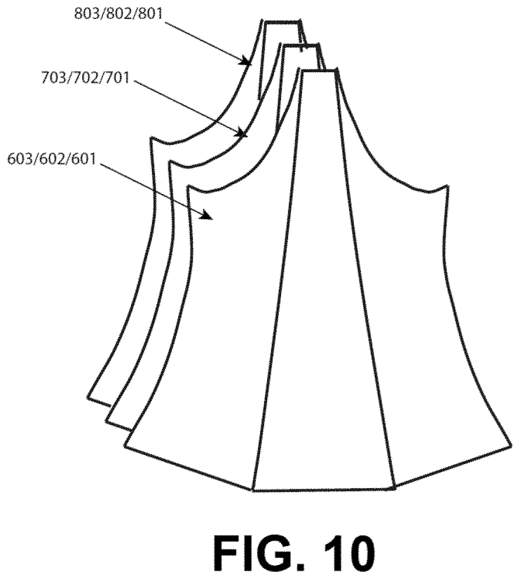

The three panels 101/102/103 all have at least three layers, the external layer 803/802/801, the intermediate layer of nonwoven interfacing 703/702/701, and the internal skin-facing layer of woven cotton 603/602/601. In an example of several possible methods of manufacture, a fabricator cuts the two layers of each panel out of woven cotton fabric and one piece of each panel out of nonwoven interfacing material. Each layer of three pieces is sewn together (for example, the external layer 803/802/801) with the edges joined as shown by the arrows in FIG. 9A, resulting in a concave fabric structure as shown in FIG. 9B, and then they are sandwiched together as shown in FIG. 10. However, this process could also occur in the reverse order, where joining of the panels 101/102/103 occurs after each three-layer panel 803/703/603, 802/702/602, 801/701/601 is fabricated.

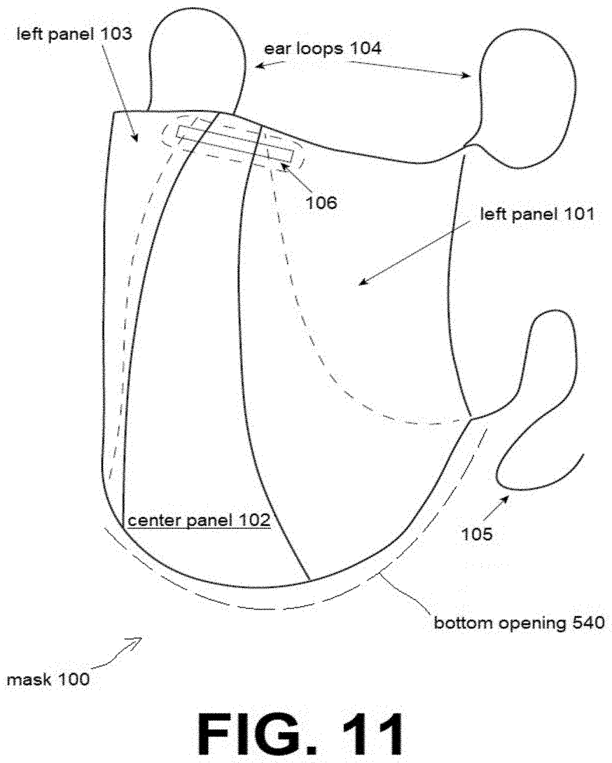

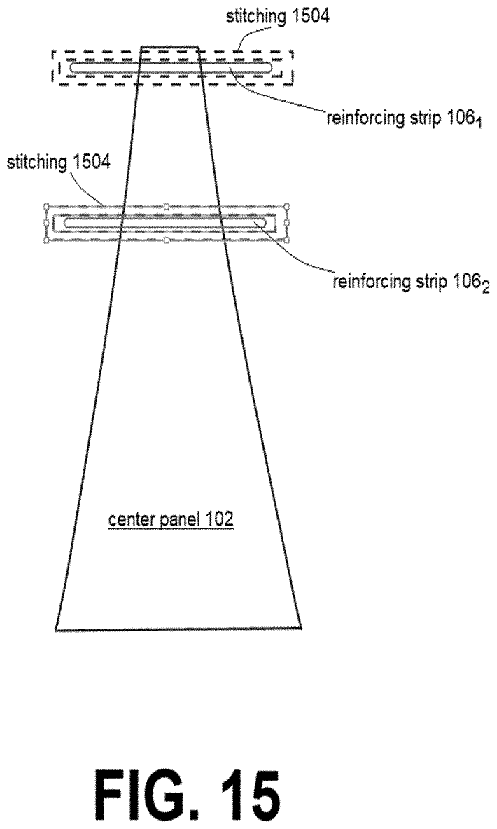

As shown in FIG. 11, the mask 100 includes the elastic ear loops 104 with the stops 520 for adjustment. Further, the elastic straps 105 which are affixed to the mask at the indicated locations and one or more flat metal center nose reinforcing strips 106 (e.g. FIG. 15) which is implanted and secured with stitching 1504 shown as a dashed line. Additional dashed lines show supplemental stitches 1504 to ensure the three layers are held together, including for example through repeated washings.

In an embodiment, a second metal strip 106 is positioned partway down the center of the mask 100 to help strengthen the cantilevered-effect of the arches, as shown in FIG. 15. This assists in maintaining the breathing space in front of the nose and mouth.

One embodiment of the mask system 100 will be a standard size, which fits young adults to adults, with elastic ear loops and straps for the fastening mechanisms 104/105. Additional models include being sized for children, and include being customized for colors or silk screened external logos. Further embodiments can be configured to enable third parties to design and sell smaller custom side panels that could be affixed to the mask.

There can be special kinds of threads in various aspects of the stitching. Further, as a substitute for some of the stitching, there may be ways to instead do heat-treatment to join the panels 101/102/103 or layers together.

### Care and Use, Usability

Singing with conventional masks means one will likely remember whatever they had for lunch. When a conventional Prior Art mask is present, the wearer can breathe hard enough to be reminded they ate tuna recently, or drank coffee recently. Beef products will also cause this smell, or certain types of soup. Meanwhile, the mask 100 avoids these problems with the cantilevered arrangement of the panel 102, which again takes advantage of the space 504 shown in FIG. 5A.

In an embodiment, the mask 100 is lined with an antimicrobial poly cotton fabric which, when activated, can kill 99.9 percent of common bacteria and viruses that come into contact therewith. Bleach can be one potential mechanism suitable to activate such fabric. It is considered optimal to dry the mask 100 using a High-Heat setting. Depending on the specific dryer, a second drying cycle may be recommended. Avoid creating a crease down the center of the middle panel 102. This may bring the fabric too close to the mouth when the mask 100 is worn.

To wear the mask 100, one would first “pop out” the middle mask panel 102 and place a top center of mask along the top of the nose. Tie at the back of the head with the top ear straps 104. To close the side-panels 101-103, tie the bottom elastic straps 105 loosely around the back of the neck.

### Other Features

Of the different churches and choirs, some are mixed-up, and some are not (straight-voice). However, with the off-the-face cantilevered nature of the mask system 100, utilizing the space 504 (FIG. 5A), sound can still travel and emanate from the mask-wearer, although that sound may be directed more downward.

While preferred embodiments of the present invention have been shown and described herein, it will be obvious those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby

What is claimed is:

1. A method of manufacturing a mask, comprising:
configuring and locating a left panel and a right panel to conform with a face of a wearer;
configuring and positioning a middle panel between the left and right panels;
joining the left and right panels together at the middle panel thereby forming mutual curvatures creating one or more supporting arches in a nose-facing area of the middle panel; and
cantilevering the material of the mask in a downward and outward direction extending away from the tip of the nose of the wearer.

2. The method of claim 1, further comprising:
forming one or more attachment mechanisms from elastic ear loops.

3. The method of claim 2, further comprising:
attaching the one or more attachment mechanism to the left and right panels.

4. The method of claim 1, further comprising:
forming one or more attachment mechanisms using elastic ties.

5. The method of claim 4, further comprising:
attaching the one or more attachment mechanism to the left and right panels.

6. The method of claim 1, further comprising:
forming the middle panel from a material that is stiffer and less bendable than the material forming the side panels, thereby assisting in the step of cantilevering.

7. The method of claim 6, further comprising:
spraying or treating the middle panel treated with a material that aids in stiffening or reacts with a higher-rigidity composition.

8. The method of claim 1, the cantilevering step further comprising:
during use of the mask system, creating a space between the nose and mouth and the two side panels and also the middle panel; such that
upon vigorous inhalation, all panels avoiding being pulled into the mouth or nose; and
upon vigorous exhalation, directing the exhaled air outward and then downward toward the panels.

9. The method of claim 1, further comprising:
positioning additional layers of filter material within the left, middle, and right panels, thereby further inhibiting the aerosolized particulate matter from exiting the mask.

10. The method of claim 1, further comprising:
fabricating the left, middle, and right panels using an external layer of woven cotton material, an intermediate layer of nonwoven interfacing material, and an interior skin-facing layer of woven cotton material.

11. The method of claim 1, further comprising:
cutting the two layers of the left, middle, and right panels out of woven cotton fabric and one piece of each panel out of nonwoven interfacing material;
sewing each layer with the edges joined, resulting in a concave fabric structure; and
sandwiching the three-layer combination together.

12. The method of claim 1, further comprising:
sandwiching the three-layer combination together;
cutting the two layers of each panel out of woven cotton fabric and one piece of each panel out of nonwoven interfacing material; and
sewing each layer of three pieces is sewn together with the edges joined, resulting in a concave fabric structure.

13. The method of claim 4, further comprising:
configuring the elastic ties to be adjustable, thereby
allowing a wearer to adjust the mask to a shape of the wearer's individual face and jaw.

14. The method of claim 2, further comprising:
configuring the elastic loops to have stops for user-adjustment embedded therein.

15. The method of claim 1, further comprising:
implanting a flat metal center nose strip into an upper interior surface of the middle panel.

16. The method of claim 1, further comprising:
securing a flat metal center nose strip at an upper interior surface of the middle panel with stitching.

17. The method of claim 1, further comprising:
customizing the mask system with silk-screened external logos.

18. The method of claim 1, further comprising:
configuring one or more of the left, middle, and right panels with predetermined blank spaces to enable third parties to design and sell smaller custom side panels that could be affixed to the mask.

19. The method of claim 1, further comprising:
incorporating special kinds of threads in various aspects of the stitching.

20. The method of claim 1, further comprising:
performing heat-treatment to join the panels together.
